(19) United States
(12) Patent Application Publication
(10) Pub. No.: US 2026/0074434 A1
(43) Pub. Date: Mar. 12, 2026

(54) REFLECTING DEVICE

(71) Applicant: Japan Display Inc., Tokyo (JP)

(72) Inventors: Shiori TEZEN, Tokyo (JP); Mitsuhiro SUGAWARA, Tokyo (JP); Masayuki IKARI, Tokyo (JP)

(73) Assignee: Japan Display Inc., Tokyo (JP)

(21) Appl. No.: 19/328,431

(22) Filed: Sep. 15, 2025

Related U.S. Application Data
(63) Continuation of application No. PCT/JP2024/006732, filed on Feb. 26, 2024.

(30) Foreign Application Priority Data
Mar. 31, 2023 (JP) 2023-058162

(51) Int. Cl. H01Q 15/14

(52) U.S. Cl. CPC H01Q 15/148

(57) ABSTRACT

A reflecting device includes an intelligent reflecting surface including
a reflecting antenna portion including multiple reflecting antenna cell and a receiving antenna portion including first and second receiving antenna cells, and a control device for controlling a reflecting direction of a radio wave reflected by the reflective antenna portion. The control device includes a radio wave acquisition section for acquiring first and second intensities of the radio waves received by the first and second receiving antenna cells, an angle deviation calculation section for calculating a first angle deviation of a normal direction to a surface of the intelligent reflecting surface in the first direction based on a difference between the first and second intensities, and a control voltage generation section for generating a control voltage supplied to each of the multiple reflecting antenna cells. The control voltage is generated based on the first angle deviation.

### CROSS-REFERENCE TO RELATED APPLICATIONS

This application is a Continuation of International Patent Application No. PCT/JP2024/006732, filed on Feb. 26, 2024, which claims the benefit of priority to Japanese Patent Application No. 2023-058162, filed on Mar. 31, 2023, the entire contents of which are incorporated herein by reference.

### FIELD

An embodiment of the present invention relates to a reflecting device that can control a traveling direction of a reflected radio wave.

### BACKGROUND

A phased array antenna device has a plurality of antenna elements arranged in a plane, and controls the directionality of a radio wave by adjusting the amplitude and phase of a high-frequency signal applied to each of the plurality of antenna elements while the phased array antenna device is fixed. The phased array antenna device requires a phase shifter. The phased array antenna device including a phase shifter that uses a change in dielectric constant due to the alignment state of a liquid crystal is disclosed (for example, see Japanese laid-open patent application No. H11-103201).

The antenna element of the phased array antenna device in Japanese laid-open patent application No. H11-103201 has a plurality of strip wirings, a planar electrode facing the plurality of strip wirings, and a liquid crystal layer between the plurality of strip wirings and the planar electrode. Different voltages are applied to the plurality of strip wirings in the plurality of antenna elements. The phase can be changed by adjusting the dielectric constant of the liquid crystal layer for each antenna element and superposing the reflected waves. In this way, the reflecting direction of the radio wave can be set in any direction.

### SUMMARY

A reflecting device according to an embodiment of the present invention includes an intelligent reflecting surface including a reflecting antenna portion for reflecting a radio wave and a receiving antenna portion for receiving the radio wave, and a control device for controlling a reflection direction of the radio wave reflected by the reflective antenna portion. The reflecting antenna portion includes a plurality of reflecting antenna cells arranged in a matrix in a first direction and a second direction orthogonal to the first direction. Each of the plurality of reflecting antenna cells includes a first patch electrode, a first ground electrode overlapping the first patch electrode, and a liquid crystal layer between the first patch electrode and the first ground electrode. The receiving antenna portion includes a first receiving antenna cell and a second receiving antenna cell disposed in the first direction from the first receiving antenna. The control device includes a radio wave acquisition section for acquiring a first intensity of the radio wave received by the first receiving antenna cell and a second intensity of the radio wave received by the second receiving antenna cell, an angle deviation calculation section for calculating a first angle deviation of a normal direction to a surface of the intelligent reflecting surface in the first direction based on a difference between the first intensity and the second intensity, and a control voltage generation section for generating a control voltage to be applied to the first patch electrode of each of the plurality of reflecting antenna cells. The control voltage is generated based on the first angle deviation.

A reflecting device according to an embodiment of the present invention includes an intelligent reflecting surface system in which a plurality of intelligent reflecting surfaces each including a reflecting antenna portion for reflecting a radio wave are arranged in a matrix in a first direction and a second direction orthogonal to the first direction, and a control device for controlling a reflection direction of the radio wave reflected by the reflective antenna portion of each of the plurality of intelligent reflecting surfaces. A first intelligent reflecting surface and a second intelligent reflecting surface disposed in the first direction from the first intelligent reflecting surface among the plurality of intelligent reflecting surfaces includes a first receiving antenna cell and a second receiving antenna cell, respectively. The reflecting antenna portion includes a plurality of reflecting antenna cells arranged in a matrix in the first direction and the second direction. Each of the plurality of reflecting antenna cells includes a first patch electrode, a first ground electrode overlapping the first patch electrode, and a liquid crystal layer between the first patch electrode and the first ground electrode. The control device includes a radio wave acquisition section for acquiring a first intensity of the radio wave received by the first receiving antenna cell and a second intensity of the radio wave received by the second receiving antenna cell, an angle deviation calculation section for calculating a first angle deviation of a normal direction to a surface of the intelligent reflecting surface in the first direction based on a difference between the first intensity and the second intensity, and a control voltage generation section for generating a control voltage to be applied to the first patch electrode of each of the plurality of reflecting antenna cells. The control voltage is generated based on the first angle deviation.

### BRIEF DESCRIPTION OF DRAWINGS

FIG. 1 is a schematic diagram illustrating a usage aspect of a reflecting device according to an embodiment of the present invention.

FIG. 2 is a schematic plan view showing an outline of a configuration of a reflecting device according to an embodiment of the present invention.

FIG. 3A is a schematic plan view showing a configuration of a reflecting antenna cell of a reflecting device according to an embodiment of the present invention.

FIG. 3B is a schematic cross-sectional view showing a configuration of a reflecting antenna cell of a reflecting device according to an embodiment of the present invention.

FIG. 4A is a schematic cross-sectional view illustrating an operation of a reflecting antenna cell of a reflecting device according to an embodiment of the present invention.

FIG. 4B is a schematic cross-sectional view illustrating an operation of a reflecting antenna cell of a reflecting device according to an embodiment of the present invention.

FIG. 5 is a schematic diagram showing a direction of a radio wave reflected by a reflecting antenna cell of a reflecting device according to an embodiment of the present invention.

FIG. 6 is a schematic cross-sectional view showing a configuration of a receiving antenna cell of a reflecting device according to an embodiment of the present invention.

FIG. 7 is a block diagram showing a configuration of a control device for a reflecting device according to an embodiment of the present invention.

FIG. 8 is a flowchart illustrating angle deviation correction processing executed by a control device of a reflecting device according to an embodiment of the present invention.

FIG. 9 is a schematic diagram illustrating a method for calculating an angle deviation executed by a control device of a reflecting device according to an embodiment of the present invention.

FIG. 10 is a schematic diagram illustrating a timing of angle deviation correction executed by a control device of a reflecting device according to an embodiment of the present invention.

FIG. 11 is a schematic cross-sectional view showing a configuration of a receiving antenna cell of a reflecting device according to an embodiment of the present invention.

FIG. 12 is a schematic cross-sectional view showing a configuration of a receiving antenna cell of a reflecting device according to an embodiment of the present invention.

FIG. 13 is a schematic plan view showing a configuration of a reflecting device according to an embodiment of the present invention.

FIG. 14 is a schematic plan view showing a configuration of a reflecting device according to an embodiment of the present invention.

### DESCRIPTION OF EMBODIMENTS

In the field of communications, the fifth generation communication standard known as 5G has been deployed. 5G uses a frequency in millimeter wave bands between 26 GHZ and 28 GHz. When a frequency is used in millimeter wave bands, 5G communication can achieve extremely high throughput and transmit signals over a wide bandwidth. However, since a frequency in millimeter wave bands has a tendency to propagate in a highly directional manner, it is difficult to navigate around obstacles. Therefore, there is a problem that the communication area that can be covered by the 5G standard is narrow in urban areas with many high-rise buildings.

In order to overcome such a problem, it may be possible to install an intelligent reflecting surface to avoid obstacles and expand the communication area, thereby changing the direction of a radio wave. However, the angle of the installed intelligent reflecting surface can change due to weather or natural disasters. In this case, it is not possible to reflect a radio wave in the intended direction.

In view of the above problem, an embodiment of the present invention can provide a reflecting device that can correct the direction of a reflected wave.

Hereinafter, embodiments of the present invention are described with reference to the drawings. However, the present invention can be implemented in many different aspects, and should not be construed as being limited to the description of the following embodiments. For the sake of clarifying the explanation, the drawings may be expressed schematically with respect to the width, thickness, shape, and the like of each part compared to the actual aspect, but this is only an example and does not limit the interpretation of the present invention. For this specification and each drawing, elements similar to those described previously with respect to previous drawings may be given the same reference sign (or a number followed by a, b, etc.) and a detailed description may be omitted as appropriate. The terms “first” and “second” appended to each component are a convenience sign used to distinguish them and have no further meaning except as otherwise explained.

As used in the present specification, where a member or region is “on” (or “under”) another member or region, this includes cases where it is not only directly on (or just under) the other member or region but also above (or below) the other member or region, unless otherwise specified. That is, it includes the case where another component is included in between above (or below) other members or regions.

### First Embodiment

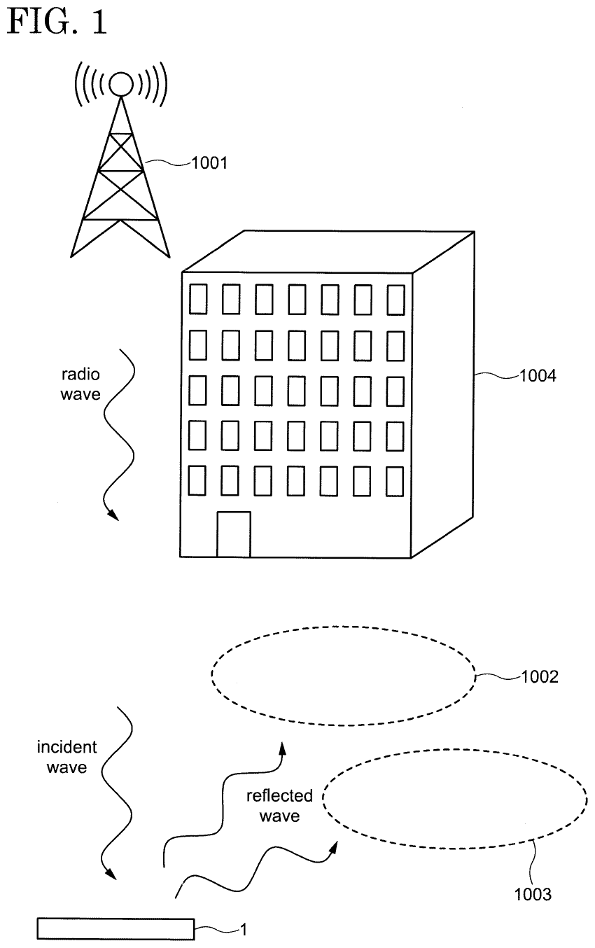

A reflecting device 1 according to an embodiment of the present invention is described with reference to FIGS. 1 to 10.

### [1. Usage Aspect of Reflecting Device 1]

FIG. 1 is a schematic diagram illustrating a usage aspect of the reflecting device 1 according to an embodiment of the present invention.

A base station 1001 is installed with an omnidirectional antenna and transmits a radio wave in all directions. However, since a radio wave transmitted from the base station 1001 is blocked by building 1004 in areas 1002 and 1003, it is difficult for a radio wave to reach these areas (or the radio wave sensitivity is reduced). Therefore, the reflecting device 1 is used to transmit a radio wave to area 1002 or area 1003 via a route that bypasses building 1004. As shown in FIG. 1, when the reflecting device 1 is installed in a position where the radio wave is not blocked by building 1004, the radio wave transmitted from the base station 1001 is reflected by the reflecting device 1 and can reach area 1002 or area 1003.

As described above, the reflecting device 1 can reflect an incident radio wave. In particular, the reflecting device 1 can directionally reflect a radio wave in a specific direction. For example, the reflecting device 1 can selectively reflect a radio wave transmitted from the base station 1001 toward either the area 1002 or the area 1003.

The reflecting device 1 is basically installed outdoors. Therefore, even when the reflecting device 1 is installed at a predetermined angle (installation angle) relative to the base station 1001, the installation angle may be shifted due to weather, disasters, or other factors. In this case, since the angle of the incident wave entering the reflecting device 1 changes, the direction of the reflected wave reflected by the reflecting device 1 also changes. As a result, a situation may occur in which the radio wave transmitted from the base station 1001 does not reach area 1002 or area 1003. In order to avoid such a situation, the reflecting device 1 can correct the reflecting direction of the radio wave in accordance with the amount of deviation in the installation angle. Therefore, the reflecting device 1 can stably reflect a radio wave in the direction of the predetermined area for a long period of time.

### [2. Outline of Configuration of Reflecting Device 1]

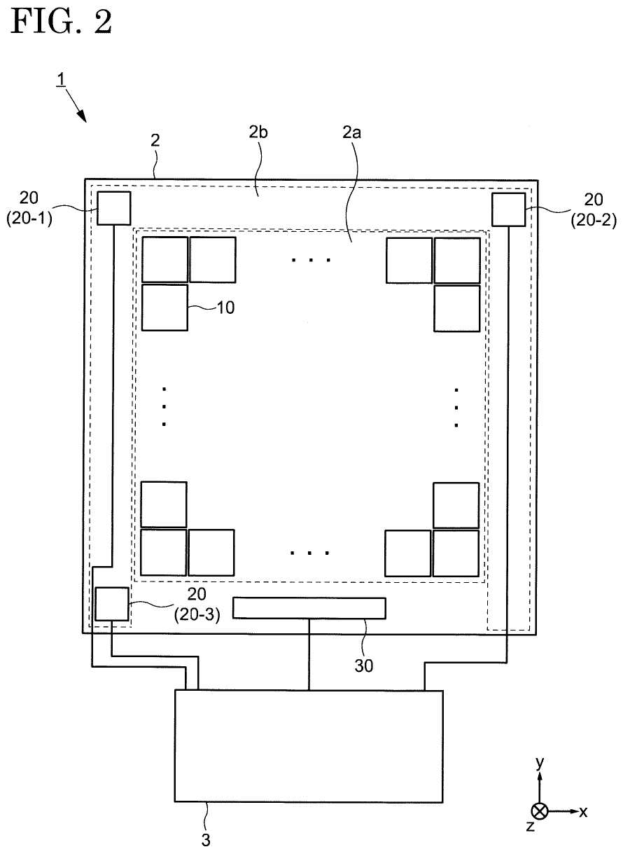

FIG. 2 is a schematic plan view showing an outline of a configuration of the reflecting device 1 according to an embodiment of the present invention.

As shown in FIG. 2, the reflecting device 1 includes an intelligent reflecting surface 2 and a control device 3. The intelligent reflecting surface 2 includes a reflecting antenna portion 2a and a receiving antenna portion 2b. The reflecting antenna portion 2a is located at the center of the intelligent reflecting surface 2, and the receiving antenna portion 2b is located around the reflecting antenna portion 2a. The reflecting antenna portion 2a is provided with a plurality of reflecting antenna cells 10. Although the plurality of reflecting antenna cells 10 are arranged in a matrix along an x-axis direction and a y-axis direction which are orthogonal to each other, the arrangement of the plurality of reflecting antenna cells 10 is not limited thereto. The receiving antenna portion 2b is provided with three receiving antenna cells 20 (a first receiving antenna cell 20-1 to a third receiving antenna cell 20-3). The second receiving antenna cell 20-2 is arranged in the x-axis direction from the first receiving antenna cell 20-1. The third receiving antenna cell 20-3 is arranged in the y-axis direction from the first receiving antenna cell 20-1. In this way, it is preferable that the three receiving antenna cells 20 are each arranged at a corner of the intelligent reflecting surface 2. Each of the three receiving antenna cells 20 is connected to the control device 3. The intelligent reflecting surface 2 is also provided with a drive circuit 30. The drive circuit 30 is connected to the control device 3 and the plurality of reflecting antenna cells 10. The drive circuit 30 converts a control voltage output from the control device 3 into a control signal that controls each of the plurality of reflecting antenna cells 10. Each of the plurality of reflecting antenna cells 10 is controlled based on the control signal output from the drive circuit 30.

### [3. Configuration of Reflecting Antenna Cell 10]

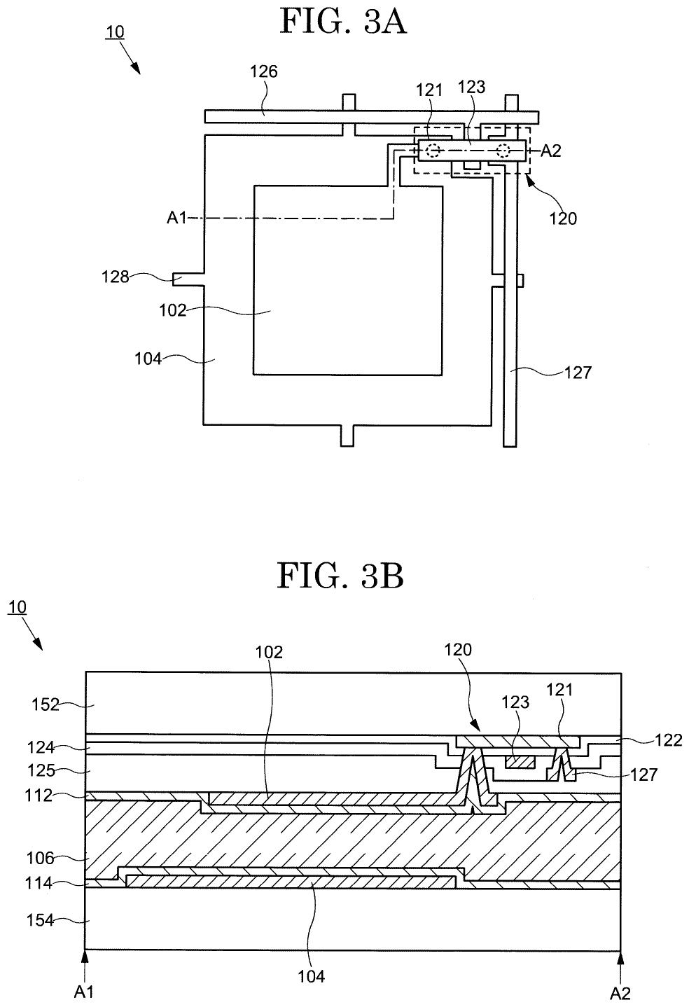

FIG. 3A is a schematic plan view showing a configuration of the reflecting antenna cell 10 of the reflecting device 1 according to an embodiment of the present invention. FIG. 3B is a schematic cross-sectional view showing a configuration of the reflecting antenna cell 10 of the reflecting device 1 according to an embodiment of the present invention. Specifically, FIG. 3B is a cross-sectional view of the reflecting antenna cell 10 taken along the line A1-A2 in FIG. 3A. In addition, a part of the configuration of the reflecting antenna cell 10 is omitted in FIG. 3A, for convenience.

As shown in FIGS. 3A and 3B, the reflecting antenna cell 10 includes a patch electrode 102 provided on a first substrate 152 and a ground electrode 104 provided on a second substrate 154. The first substrate 152 and the second substrate 154 are arranged so that the patch electrode 102 and the ground electrode 104 face each other. A first alignment film 112 and a second alignment film 114 are provided on the patch electrode 102 and the ground electrode 104, respectively. Further, a liquid crystal layer 106 is provided between the first alignment film 112 and the second alignment film 114. That is, the initial alignment of the liquid crystal molecules in the liquid crystal layer 106 is controlled by the first alignment film 112 and the second alignment film 114. Further, the alignment state of the liquid crystal molecules in the liquid crystal layer 106 can be changed by the voltage applied to the patch electrode 102.

In addition, the radio wave transmitted from the base station 1001 is incident on the first substrate 152 side.

In a plan view, the area of the patch electrode 102 is smaller than the area of the ground electrode 104. Although the shape of each of the patch electrode 102 and the ground electrode 104 is a square, the shape is not limited thereto. The shape of each of the patch electrode 102 and the ground electrode 104 may be, for example, a rectangle or another geometric shape.

The patch electrode 102 is electrically connected to a switching element 120. The switching element 120 includes a semiconductor layer 121, a gate insulating layer 122, and a gate electrode 123. Although the switching element 120 shown in FIGS. 3A and 3B is a so-called transistor, the configuration of the switching element 120 is not limited thereto. The switching element 120 is provided on the first substrate 152. The semiconductor layer 121 is provided on the first substrate 152. The gate electrode 123 is provided so as to overlap the semiconductor layer 121. The gate electrode 123 is electrically connected to a selection signal line 126. The gate insulating layer 122 is provided between the semiconductor layer 121 and the gate electrode 123. Further, an interlayer insulating layer 124 is provided over the gate electrode 123. Two openings are formed in the interlayer insulating layer 124 to expose the semiconductor layer 121. The semiconductor layer 121 is electrically connected to the patch electrode 102 through one opening, and is electrically connected to a data signal line 127 through the other opening. A planarizing layer 125 is provided over the interlayer insulating layer 124 and the data signal line 127. The patch electrode 102 is provided on the planarizing layer 125.

The selection signal line 126 and the data signal line 127 are electrically connected to a drive circuit 30. A control signal from the drive circuit 30 is input to the switching element 120 through the selection signal line 126 and the data signal line 127. The switching element 120 operates based on the control signal, thereby changing the alignment state of the liquid crystal molecules in the liquid crystal layer 106. In addition, the operation of the reflecting antenna cell 10 is described in detail later.

The ground electrode 104 is electrically connected to a ground wiring 128. The ground electrode 104 and the ground wiring 128 may be formed of the same conductive layer. The ground wiring 128 electrically connects adjacent ground electrodes 104 to each other. The ground electrodes 104 arranged in a matrix have an equipotential by connecting the ground electrodes 104 to each other by the ground wiring 128.

The liquid crystal layer 106 includes a liquid crystal material having dielectric anisotropy. For example, a nematic liquid crystal, a smectic liquid crystal, a cholesteric liquid crystal, a discotic liquid crystal, or the like can be used as the liquid crystal material of the liquid crystal layer 106. In the liquid crystal layer 106, the dielectric constant changes depending on the alignment state of the liquid crystal molecules.

Glass, quartz, or resin can be used for each of the first substrate 152 and the second substrate 154. Each layer over the first substrate 152 and the second substrate 154 is formed using the following materials. The semiconductor layer 121 is formed using a silicon semiconductor such as amorphous silicon or polycrystalline silicon, or an oxide semiconductor such as indium gallium zinc oxide, indium gallium aluminum oxide, indium gallium oxide, zinc oxide, or gallium oxide. For example, the gate insulating layer 122 and the interlayer insulating layer 124 are formed using a silicon oxide film, or a laminated structure of a silicon oxide film and a silicon nitride film. For example, the selection signal line 126 and the gate electrode 123 are formed using molybdenum (Mo), tungsten (W), or an alloy thereof. The data signal line 127 is formed using a metal material such as titanium (Ti), aluminum (Al), or molybdenum (Mo). For example, the data signal line 127 is formed of a titanium (Ti)/aluminum (Al)/titanium (Ti) laminated structure or a molybdenum (Mo)/aluminum (Al)/molybdenum (Mo) laminated structure. The planarization layer 125 is formed using a resin material such as acrylic or polyimide. The patch electrode 102 and the ground electrode 104 are formed using a metal film such as aluminum (Al) or copper (Cu), or a transparent conductive film such as indium tin oxide (ITO).

### [4. Operation of Reflecting Antenna Cell 10]

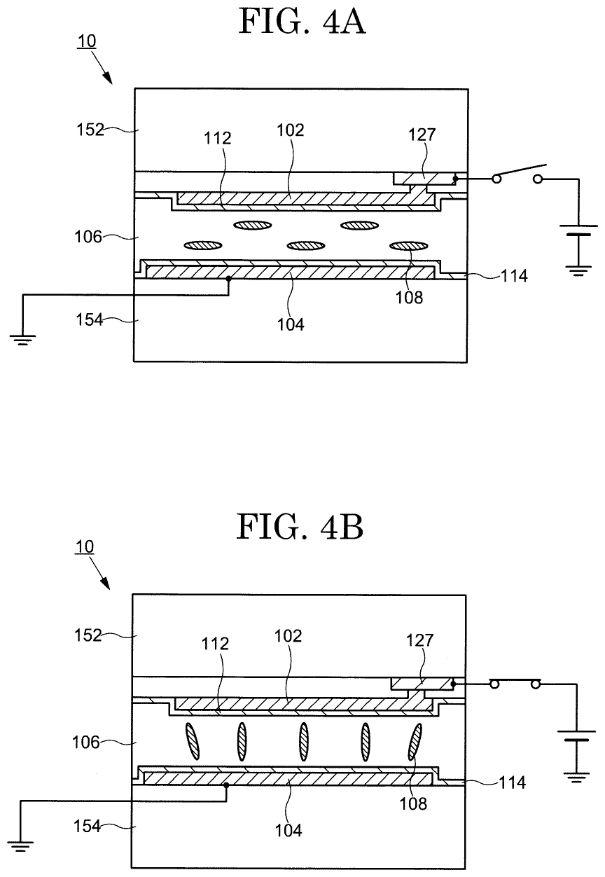

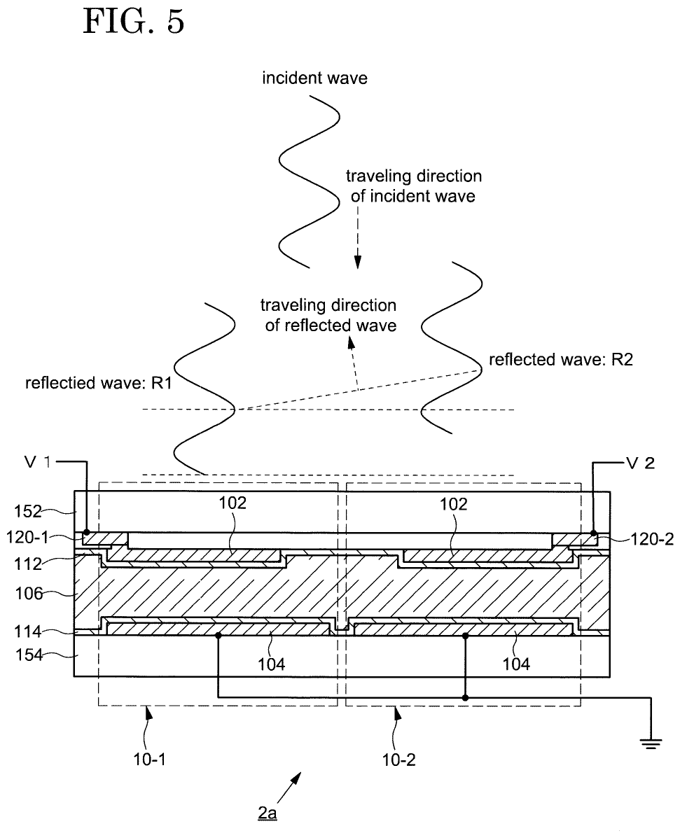

Each of FIGS. 4A and 4B is a schematic cross-sectional view illustrating an operation of the reflecting antenna cell 10 of the reflecting device 1 according to an embodiment of the present invention. Specifically, FIG. 4A shows a state (a first state) in which no voltage is applied to the patch electrode 102 of the reflecting antenna cell 10, and FIG. 4B shows a state (a second state) in which a voltage is applied to the patch electrode 102 of the reflecting antenna cell 10. Further, FIG. 5 is a schematic diagram showing a direction of a radio wave reflected by the reflecting antenna cell 10 of the reflecting device 1 according to an embodiment of the present invention.

The first alignment film 112 and the second alignment film 114 shown in FIGS. 4A and 4B are horizontal alignment films. That is, as shown in FIG. 4A, the long axes of the liquid crystal molecules 108 in the liquid crystal layer 106 are aligned horizontally in the first state due to the alignment restriction force of the first alignment film 112 and the second alignment film 114. In other words, in the first state, the long axes of the liquid crystal molecules 108 are aligned horizontally relative to the surfaces of the patch electrode 102 and the ground electrode 104. In the second state, a voltage that changes the alignment state of the liquid crystal molecules 108 is applied to the patch electrode 102. In the second state, the long axes of the liquid crystal molecules 108 are aligned perpendicular to the surfaces of the patch electrode 102 and the ground electrode 104 under the influence of the electric field generated by the voltage applied to the patch electrode 102. The angle at which the long axes of the liquid crystal molecules 108 are aligned can be controlled by the magnitude of the voltage applied to the patch electrode 102, and the liquid crystal molecules 108 can also be aligned at an angle between horizontal and vertical.

When the liquid crystal molecules 108 have positive dielectric anisotropy, the dielectric constant is greater in the second state (see FIG. 4B) than in the first state (see FIG. 4A). When the liquid crystal molecules 108 have negative dielectric anisotropy, the apparent dielectric constant is smaller in the second state than in the first state. The liquid crystal layer 106 formed of a liquid crystal with dielectric anisotropy can also be considered a variable dielectric layer. When the dielectric anisotropy of the liquid crystal layer 106 is used, the reflecting antenna cell 10 can control the phase delay (or non-delay) of a radio wave scattered by the ground electrode 104.

The frequency band to which the intelligent reflecting surface 10 is applicable are the very high frequency (VHF) band, the ultra-high frequency (UHF) band, the super high frequency (SHF) band, the tremendously high frequency (THF) band, and the extra high frequency (EHF) band. In the liquid crystal layer 106, the alignment of the liquid crystal molecules 108 changes depending on the voltage applied to the patch electrode 102. However, the alignment of the liquid crystal molecules does not follow the frequency of the radio wave incident on the ground electrode 104. Due to such characteristics of the liquid crystal molecules 108, it is possible to change the dielectric constant of the liquid crystal layer 106 by the patch electrode 102 while scattering the radio wave at the ground electrode 104 and control the phase of the scattered radio wave.

FIG. 5 shows an incident wave traveling parallel to the normal direction of the surface of the first substrate 152. A first voltage V1 is applied to the patch electrode 102 of the first reflecting antenna cell 10-1 from the first data signal line 120-1, and a second voltage V2 different from the first voltage V1 is applied to the patch electrode 102 of the second reflecting antenna cell 10-2 from the second data signal line 120-2. In addition, the ground electrode 104 of the first reflecting antenna cell 10-1 and the ground electrode 104 of the second reflecting antenna cell 10-2 have the same potential, that is, the same voltage (e.g., GND) is applied to the ground electrodes 104.

When radio waves having the same phase are incident on the first reflecting antenna cell 10-1 and the second reflecting antenna cell 10-2, different voltages (V1≠V2) are applied to the first reflecting antenna cell 10-1 and the second reflecting antenna cell 10-2, and therefore the phases of the scattered waves are different between the first reflecting antenna cell 10-1 and the second reflecting antenna cell 10-2. For example, as shown in FIG. 5, the phase of the scattered wave R2 scattered by the second reflecting antenna cell 10-2 is ahead of the phase of the scattered wave R1 scattered by the first reflecting antenna cell 10-1. In this case, the reflected wave travels in a direction different from the normal direction of the surface of the first substrate 152.

As shown in FIG. 5, the phases of the scattered waves relative to the incident wave can be made different between the first reflecting antenna cell 10-1 and the second reflecting antenna cell 10-2 in the reflecting antenna portion 2a. Although two reflecting antenna cells 10 are shown in FIG. 5, it is possible to control the traveling direction of the reflected wave (i.e., the reflecting direction of the radio wave) to any direction while keeping the position of the intelligent reflecting surface 2 fixed by separately controlling a plurality of reflecting antenna cells 10 arranged in a matrix.

### [5. Configuration of Receiving Antenna Cell 20]

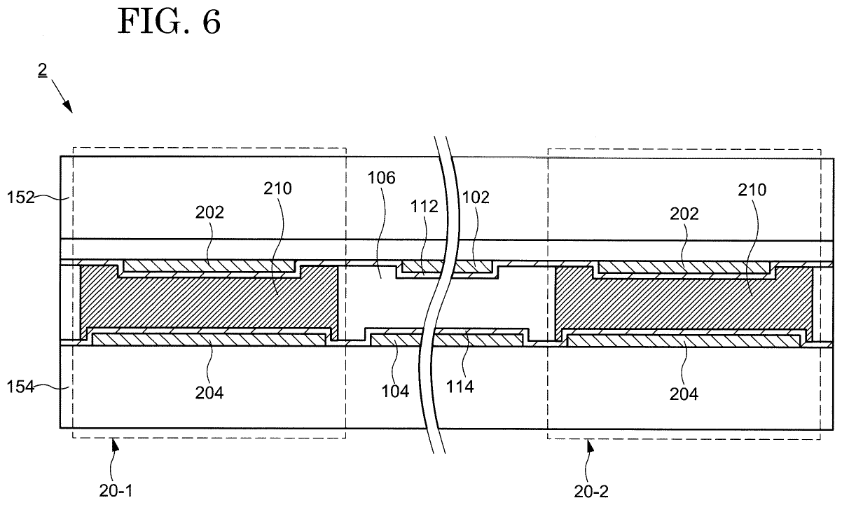

FIG. 6 is a schematic cross-sectional view showing a configuration of the receiving antenna cell 20 of the reflecting device 1 according to an embodiment of the present invention. FIG. 6 shows two (a first receiving antenna cell 20-1 and a second receiving antenna cell 20-2) of the three receiving antenna cells 20 arranged at the corners of the intelligent reflecting surface 2.

As shown in FIG. 6, the first substrate 152 and the second substrate 154 are bonded to each other by a sealing member 210 that surrounds the liquid crystal layer 106. That is, the liquid crystal layer 106 is sealed within the area surrounded by the first substrate 152, the second substrate 154, and the sealing member 210. The first receiving antenna cell 20-1 and the second receiving antenna cell 20-2 are each provided so as to overlap the sealing member 210. Each of the first receiving antenna cell 20-1 and the second receiving antenna cell 20-2 includes a receiving patch electrode 202 provided on the first substrate 152 and a receiving ground electrode 204 provided on the second substrate 154. The sealing member 210 is provided between the receiving patch electrode 202 and the receiving ground electrode 204. The receiving antenna cell 20 is able to receive a radio wave by using the sealing member 210 as a dielectric.

The receiving patch electrode 202 and the receiving ground electrode 204 can be formed in the same layer as the patch electrode 102 and the ground electrode 104, respectively. In a plan view, the area of the receiving patch electrode 202 is smaller than the area of the receiving ground electrode 204. Although the shape of each of the receiving patch electrode 202 and the receiving ground electrode 204 is, for example, a square, the shape is not limited thereto. The shape of each of the receiving patch electrode 202 and the receiving ground electrode 204 may be a rectangle or another geometric shape.

The sealing member 210 may contain a gap material to maintain a constant distance between the receiving patch electrode 202 and the receiving ground electrode 204. The gap material contained in the sealing member 210 may be the same as or different from the gap material contained in the liquid crystal layer 106.

### [6. Configuration of Control Device 3]

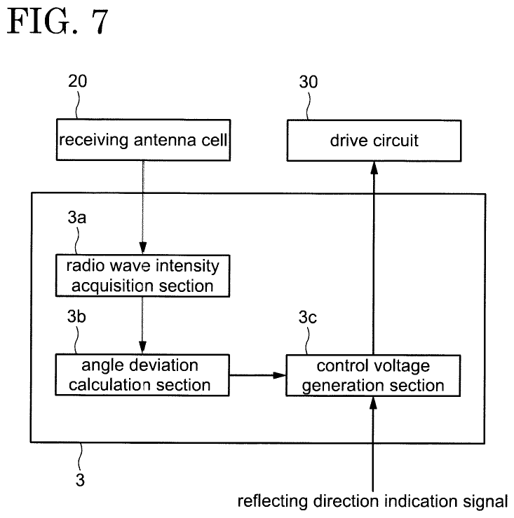

FIG. 7 is a block diagram showing a configuration of the control device 3 of the reflecting device 1 according to an embodiment of the present invention.

As shown in FIG. 7, the control device 3 includes a radio wave intensity acquisition section 3a, an angle deviation calculation section 3b, and a control voltage generation section 3c. When a reflecting direction indication signal indicating the traveling direction of the reflected wave (i.e., the reflecting direction of the radio wave) from the reflecting device 1 is input to the control device 3 via a wired or wireless communication connection, the control voltage generation section 3c generates a control voltage to be applied to the patch electrode 102 of each of the plurality of reflecting antenna cells 10 based on the reflecting direction indication signal. The generated control voltage is transmitted to the drive circuit 30, and is converted by the drive circuit 30 into a control signal that controls each of the plurality of reflecting antenna cells 10.

However, the reflecting direction indication signal input to the control device 3 does not include information regarding the position of the intelligent reflecting surface 2. Therefore, if the current installation angle of the intelligent reflecting surface 2 deviates from the installation angle at the time of installation, the radio waves will be reflected in a direction different from the direction indicated by the reflecting direction indication signal. Therefore, in the reflecting device 1, the control voltage generation section 3c uses information about the radio wave received by the receiving antenna cells 20 to correct the control voltage generated by the control voltage generation section 3c. Specifically, the radio wave intensity acquisition section 3a acquires the intensity of each radio wave received by the three receiving antenna cells 20. The angle deviation calculation section 3b calculates the angle deviation of the installation angle of the intelligent reflecting surface 2 based on the acquired radio wave intensities. For example, the angle deviation in the x-axis direction or y-axis direction normal to the surface of the intelligent reflecting surface 2 is calculated. The control voltage generation section 3c corrects the reflecting direction based on the reflecting direction indication signal and the calculated angle deviation, and generates a control voltage to be applied to each patch electrode 102 of the plurality of reflecting antenna cells 10.

The radio wave intensity acquisition section 3a is, for example, a spectrum analyzer, etc. The radio wave intensity acquisition section 3a acquires at least the intensities of radio waves from the three receiving antenna cells 20.

The angle deviation calculation section 3b and the control voltage generation section 3c are, for example, a central processing unit (CPU), a microprocessor (MPU), or an integrated circuit (IC) chip. The angle deviation calculation section 3b calculates the angle deviation from the difference in intensities of the two radio waves. The control voltage generation section 3c determines the angle deviation to generate a control voltage corrected based on the angle deviation under predetermined conditions.

### [7. Angle Deviation Correction Processing in Control Device 3]

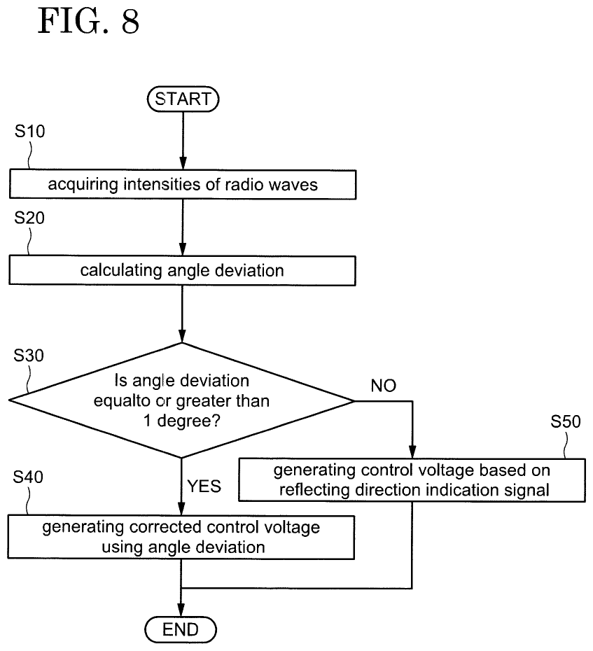

FIG. 8 is a flowchart illustrating angle deviation correction processing executed by the control device 3 of the reflecting device 1 according to an embodiment of the present invention.

The deviation correction processing as shown in FIG. 8 includes steps S10 to S50. Hereinafter, although steps S10 to S50 are described in order, the angle deviation correction processing executed by the control device 3 is not limited to the steps S10 to S50. The angle deviation correction processing may include steps other than steps S10 to S50.

In step S10, the radio wave intensity acquisition section 3a acquires the intensities of radio waves (incident waves) from the three receiving antenna cells 20.

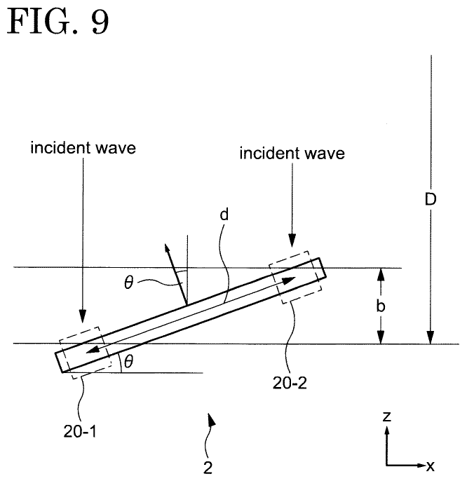

In step S20, the angle deviation calculation section 3b calculates the angle deviation in each of the first and second directions from the acquired three intensities. Here, a method for calculating the angle deviation between two points is described with reference to FIG. 9.

FIG. 9 is a schematic diagram illustrating a method for calculating an angle deviation executed by the control device 3 of the reflecting device 1 according to an embodiment of the present invention.

FIG. 9 shows the intelligent reflecting surface 2 installed at a distance D from the base station 1001. The first receiving antenna cell 20-1 and the second receiving antenna cell 20-2 arranged along the x-axis direction are separated by a distance d. Further, the installation angle of the intelligent reflecting surface 2 is shifted from the installation angle at the time of installation, and the angle deviation is e.

A first intensity L₁ of the radio wave (wavelength: A) transmitted from the base station 1001 and received by the first receiving antenna cell 20-1 is expressed by equation (1).

$${L}_{1} = 22 + 20 log 10 ( \frac{D}{λ} ) \qquad ( 1 )$$

On the other hand, the second receiving antenna cell 20-2 is closer to the base station 1001 by a distance b than the first receiving antenna cell 20-1. Therefore, the second intensity L₂ of the radio wave transmitted from the base station 1001 and received by the second receiving antenna cell 20-2 is expressed by equation (2).

$${L}_{2} = 22 + 20 log 10 ( \frac{D - b}{λ} ) \qquad ( 2 )$$

Therefore, the difference between the first intensity L₁ and the second intensity L₂ is expressed by equation (3) using equations (1) and (2).

$${L}_{1} - {L}_{2} = 20 log ( \frac{D}{D - b} ) \qquad ( 3 )$$

Here, the distance b is expressed by equation (4) using the angle deviation e.

$$b = d sin θ \qquad ( 4 )$$

Therefore, the angle deviation amount θ is expressed by equation (5) using equations (3) and (4).

$$θ = {sin}^{- 1} \frac{D}{d} ( {e}^{\frac{{L}_{1} - {L}_{2}}{20}} - 1 ) \qquad ( 5 )$$

As can be seen from equation (5), the angle deviation θ can be calculated from the first intensity L₁ and the second intensity L₂. Therefore, the angle deviation calculation section 3b calculates the angle deviation θ based on the intensities acquired by the radio wave intensity acquisition section 3a and equation (5). In addition, the angle deviation calculation section 3b can also calculate the angle deviation θ by referring to a lookup table in which the difference between the two intensities (L₁-L₂) and the angle deviation θ are associated.

The steps after step S30 are described with reference to FIG. 8 again.

In step S30, the control voltage generation section 3c determines whether the calculated angle deviation is equal to or greater than 1 degree. When the angle deviation is equal to or greater than 1 degree (step S30: YES), step S40 is executed. When the angle deviation is less than 1 degree (step S30: NO), step S50 is executed.

In step S40, the control voltage generation section 3c generates a control voltage based on the reflecting direction indication signal and the angle deviation. That is, in step S40, a control voltage in which the angle deviation of the installation angle of the intelligent reflecting surface 2 is corrected is generated.

In step S50, the control voltage generation section 3c generates a control voltage based only on the reflecting direction indication signal.

The control voltage generated in step S40 or step S50 is transmitted to the drive circuit 30. This completes the angle deviation correction processing.

The angle deviation correction processing can be executed as needed.

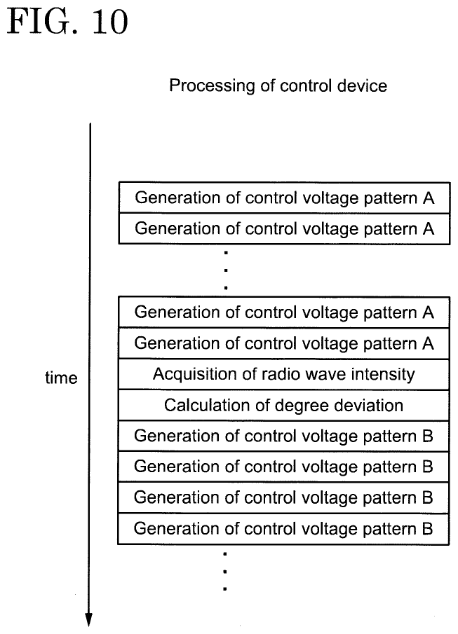

For example, the angle deviation correction processing may be executed when a reflecting direction indication signal is received. The angle deviation correction processing may also be executed in synchronization with the generation of a control signal from the drive circuit 30. Here, the timing for executing the angle deviation correction processing is described with reference to FIG. 10.

FIG. 10 is a schematic diagram illustrating a timing of the angle deviation correction processing executed by the control device 3 of the reflecting device 1 according to an embodiment of the present invention.

FIG. 10 shows the time evolution of the processing of the control device 3. The control voltage generation section 3c generates a control voltage pattern A to be applied to each patch electrode 102 of the plurality of reflecting antenna cells 10 based on the reflecting direction indication signal. In order to refresh the reflecting antenna cells 10, the control voltage pattern is repeatedly generated at a predetermined period. On the other hand, the angle deviation correction processing does not have to be executed each time a control voltage pattern is generated. In other words, the angle deviation correction processing may be executed after a predetermined number of control voltage patterns are generated. For example, after the generation of 100 frames of the control voltage pattern A is repeated, the radio wave intensity acquisition section 3a acquires the radio wave intensity, the angle deviation calculation section 3b calculates the angle deviation, and the control voltage generation section 3c generates a control voltage pattern B in which the angle deviation is corrected. Further, once the angle deviation correction processing is executed as shown in FIG. 10, the control voltage generation section 3c repeatedly generates the corrected control voltage pattern B.

### Modification of First Embodiment

In the present embodiment, it is possible to modify the configuration of the reflecting device 1 in various ways. In the following description, some modifications of the receiving antenna cell 20 of the reflecting device 1 are described. Hereinafter, descriptions of configurations similar to the configuration described above are omitted.

### <Modification 1>

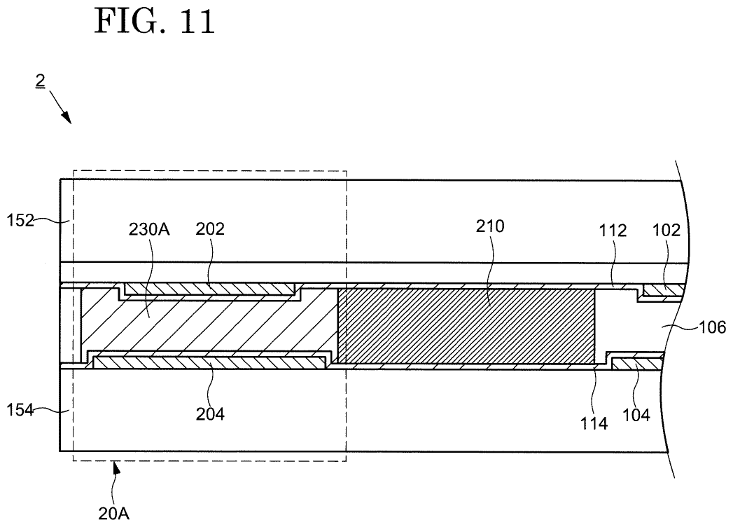

One modification of the reflecting device 1 according to an embodiment of the present invention is described with reference to FIG. 11.

FIG. 11 is a schematic cross-sectional view showing a configuration of a receiving antenna cell 20A of the reflecting device 1 according to an embodiment of the present invention.

As shown in FIG. 11, the receiving antenna cell 20A includes the receiving patch electrode 202 provided on the first substrate 152, the receiving ground electrode 204 provided on the second substrate 154, and a dielectric 230A between the receiving patch electrode 202 and the receiving ground electrode 204. The receiving antenna cell 20A is provided outside the sealing member 210. In the receiving antenna cell 20A, the dielectric 230A, which is different from the sealing member 210, functions as a phase shifter. Therefore, the dielectric 230A can have a larger dielectric constant than the sealing member 210. The dielectric 230A can be appropriately selected depending on the frequency band to which the receiving antenna cell 20A is applied. For example, when the resonant frequency is 28 GHz and the size of the receiving patch electrode 202 is 2 mm×2 mm, epoxy resin, acrylic resin, or the like can be used for the dielectric 230A.

In FIG. 11, the first alignment film 112 is provided between the receiving patch electrode 202 and the dielectric 230A, and the second alignment film 114 is provided between the receiving ground electrode 204 and the dielectric 230A. However, a configuration in which the first alignment film 112 and the second alignment film 114 are not provided can also be applied to the receiving antenna cell 20A.

### <Modification 2>

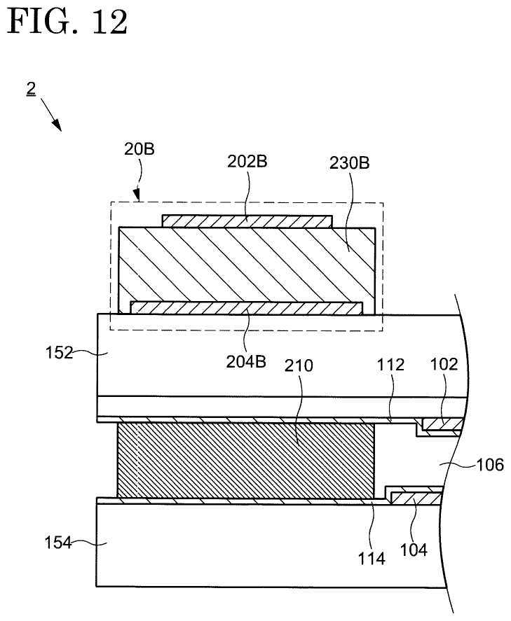

Another modification of the reflecting device 1 according to an embodiment of the present invention is described with reference to FIG. 12.

FIG. 12 is a schematic cross-sectional view showing a configuration of a receiving antenna cell 20B of the reflecting device 1 according to an embodiment of the present invention.

As shown in FIG. 12, the receiving antenna cell 20B overlaps the sealing member 210 and is provided on the surface of the first substrate 152 on which a radio wave is incident. That is, the receiving antenna cell 20B is provided over the reflecting antenna cell 10. The receiving antenna cell 20B includes a receiving patch electrode 202B, a receiving ground electrode 204B, and a dielectric 230B between the receiving patch electrode 202B and the receiving ground electrode 204B. The materials of the receiving patch electrode 202B and the receiving ground electrode 204B may be the same as or different from the materials of the patch electrode 102 and the ground electrode 104, respectively. Further, a dielectric 230B can be made of the same material as the dielectric 230A. Since the receiving antenna cell 20B can be formed independently of the reflecting antenna cell 10, the dielectric constant and the thickness (the distance between the receiving patch electrode 202B and the receiving ground electrode 204B) of the dielectric 230B can be adjusted independently of the distance between the patch electrode 102 and the ground electrode 104 of the reflecting antenna cell 10.

In FIG. 12, although the receiving antenna cell 20B is provided so as to overlap the sealing member 210, a configuration in which the receiving antenna cell 20B is provided so as not to overlap the sealing member 210 can also be applied to the receiving antenna cell 20B.

The reflecting device 1 according to an embodiment of the present invention and the modifications are described above. The reflecting device 1 includes not only the reflecting antenna portion 2a in which the plurality of reflecting antenna cells 10 that control the reflecting direction of an incident radio wave are arranged, but also a receiving antenna portion 2b in which three receiving antenna cells 20 that receive the incident radio wave are arranged. Further, the reflecting device 1 includes the control device 3 that acquires the intensities of the radio waves received by the receiving antenna cells 20 and calculates the angle deviation of the installation angle of the intelligent reflecting surface 2 based on the radio wave intensities. Furthermore, the control device 3 can generate a control voltage in which the reflecting direction is corrected based on the angle deviation. Therefore, the reflecting device 1 can accurately reflect a radio wave in a predetermined direction regardless of the installation angle of the intelligent reflecting surface 2.

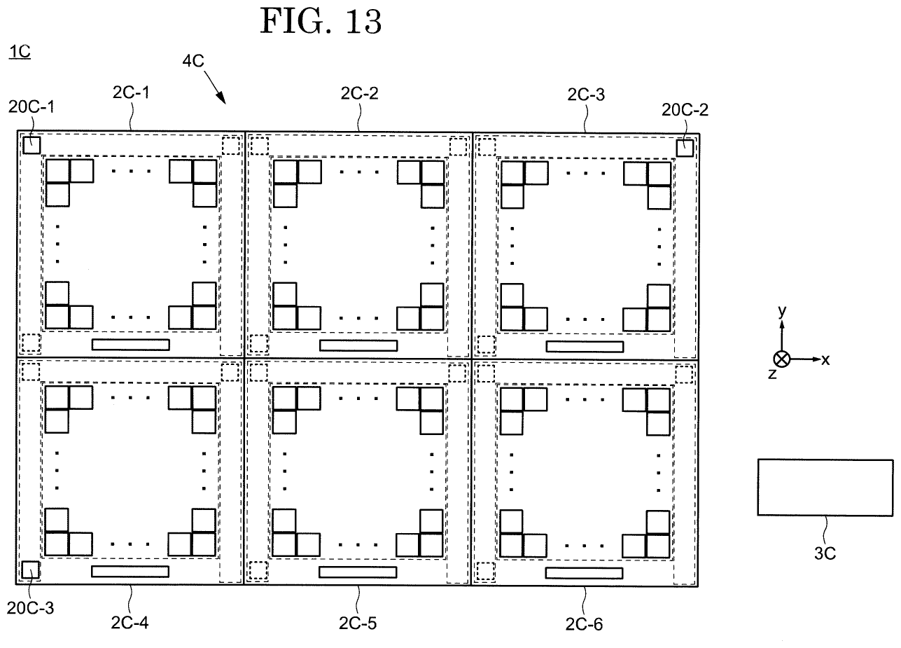

A reflecting device 1C according to an embodiment of the present invention is described with reference to FIG. 13.

FIG. 13 is a schematic plan view showing a configuration of the reflecting device 1C according to an embodiment of the present invention.

As shown in FIG. 13, the reflecting device 1C includes an intelligent reflecting surface system 4C and a control device 3C. The intelligent reflecting surface system 4C is configured by combining six intelligent reflecting surfaces 2C (a first intelligent reflecting surface 2C-1 to a sixth intelligent reflecting surface 2C-6) and has a rectangular shape in a plan view. That is, the six intelligent reflecting surfaces 2C are arranged in a 2-row×3-column matrix so that the planar shape is rectangular. More specifically, in the first row, the first intelligent reflecting surface 2C-1, the second intelligent reflecting surface 2C-2, and the third intelligent reflecting surface 2C-3 are arranged in order in the x-axis direction, and in the second row, the fourth intelligent reflecting surface 2C-4, the fifth intelligent reflecting surface 2C-5, and the sixth intelligent reflecting surface 2C-6 are arranged in order in the x-axis direction. Adjacent intelligent reflecting surfaces 2C are connected to each other, and the plurality of intelligent reflecting surfaces 2C cannot be moved individually. The six intelligent reflecting surfaces 2C can be moved as the integrated intelligent reflecting surface system 4C. The configuration of the intelligent reflecting surface 2C is the same as the configuration of the intelligent reflecting surface 2 described in the First Embodiment. Therefore, each of the plurality of intelligent reflecting surfaces 2C is provided with a reflecting antenna portion corresponding to the reflecting antenna portion 2a and a receiving antenna portion corresponding to the receiving antenna portion 2b of the intelligent reflecting surface 2.

In the reflecting device 1C, the control device 3C can independently control the reflecting antenna portions of the plurality of intelligent reflecting surfaces 2C included in the intelligent reflecting surface system 4C. Therefore, the reflecting direction of the incident radio wave can be set for each intelligent reflecting surface 2C in the reflecting device 1C. For example, the first intelligent reflecting surface 2C-1 can reflect a radio wave in a first direction, while the second intelligent reflecting surface 2C-2 can reflect a radio wave in a second direction different from the first direction.

Each of the receiving antenna portions of the plurality of intelligent reflecting surfaces 2C is provided with the receiving antenna cells corresponding to the receiving antenna cells 20 of the intelligent reflecting surface 2. However, only some of these are electrically connected to the control device 3C. Specifically, the first receiving antenna cell 20C-1 of the first intelligent reflecting surface 2C-1, the second receiving antenna cell 20C-2 of the third intelligent reflecting surface 2C-3, and the third receiving antenna cell 20C-3 of the fourth intelligent reflecting surface 2C-4, which are located at the corners of the intelligent reflecting surface system 4C, are electrically connected to the control device 3C (the receiving antenna cells indicated by dotted lines in FIG. 13 are not electrically connected to the control device 3C). Therefore, the control device 3C can acquire the intensity of the radio wave from each of the first receiving antenna cell 20C-1 to the third receiving antenna cell 20C-3. Here, with the first receiving antenna cell 20C-1 as the reference, the second receiving antenna cell 20C-2 is located in the x-axis direction, and the third receiving antenna cell 20C-3 is located in the y-axis direction. Therefore, the control device 3C can calculate an angle deviation θ₁₂ corresponding to the angle between the x-axis direction and the z-axis direction (corresponding to the normal direction to the surface of the intelligent reflecting surface system 4C) based on the intensities of the radio waves received by the first receiving antenna cell 20C-1 and the second receiving antenna cell 20C-2. Further, the control device 3C can calculate an angle deviation θ₁₃ corresponding to the angle between the y-axis direction and the z-axis direction based on the intensities of the radio waves received by the first receiving antenna cell 20C-1 and the third receiving antenna cell 20C-3. When the calculated angle deviation θ₁₂ and angle deviation θ₁₃ are equal to or greater than a threshold value (e.g., 1 degree), the control device 3C corrects the reflecting direction of each of the plurality of intelligent reflecting surfaces 2C of the intelligent reflecting surface system 4C based on the angle deviation θ₁₂ and angle deviation θ₁₃.

In addition, although FIG. 13 shows the six intelligent reflecting surfaces 2C, the number of intelligent reflecting surfaces 2C included in the intelligent reflecting surface system 4C of the reflecting device 1C is not limited to six. The intelligent reflecting surface system 4C may include a plurality of intelligent reflecting surfaces 2C, each of whose reflecting direction is controlled by the control device 3C. Further, the shape of the intelligent reflecting surface system 4C in a plan view is not limited to a rectangle, and may be another geometric shape.

### Modification of Second Embodiment

In the present embodiment, it is possible to modify the configuration of the reflecting device 1C in various ways. In the following description, a reflecting device 1D, which is one modification of the reflecting device 1C, is described. Hereinafter, a description of a configuration similar to the configurations described above is omitted.

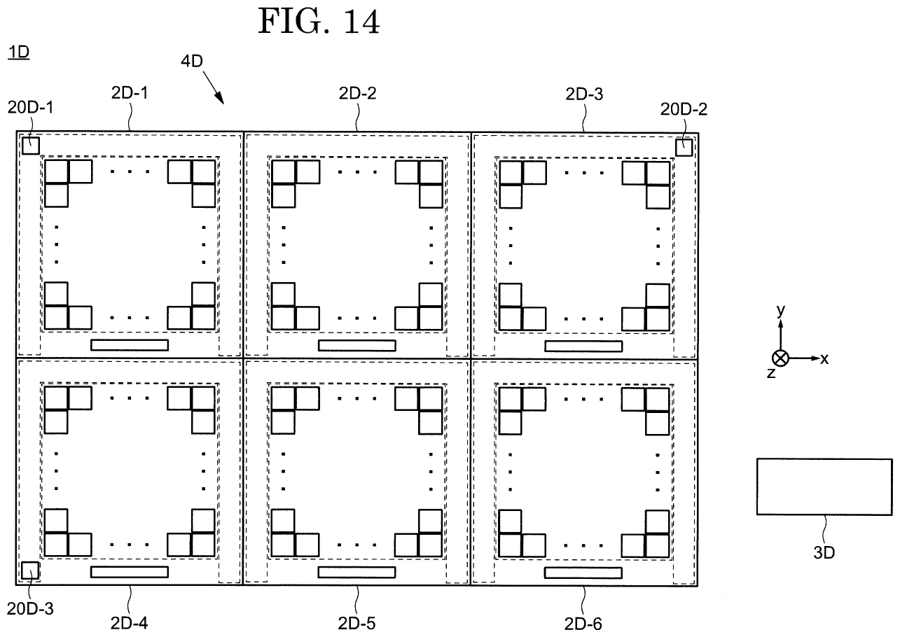

The reflecting device 1D according to an embodiment of the present invention is described with reference to FIG. 14.

FIG. 14 is a schematic plan view showing a configuration of the reflecting device 1D according to an embodiment of the present invention.

As shown in FIG. 14, the reflecting device 1D includes an intelligent reflecting surface system 4D and a control device 3D. The intelligent reflecting surface system 4D is configured by combining six intelligent reflecting surfaces 2D (a first intelligent reflecting surface 2D-1 to a sixth intelligent reflecting surface 2D-6) and has a rectangular shape in a plan view. The first intelligent reflecting surface 2D-1, third intelligent reflecting surface 2D-3, and fourth intelligent reflecting surface 2D-4 include corners of the intelligent reflecting surface system 4D. In the intelligent reflecting surface system 4D, three receiving antenna cells are provided at the corners of the intelligent reflecting surface system 4D. That is, the first intelligent reflecting surface 2D-1, third intelligent reflecting surface 2D-3, and fourth intelligent reflecting surface 2D-4 are provided with a first receiving antenna cell 20D-1, a second receiving antenna cell 20D-2, and a third receiving antenna cell 20D-3, respectively, which are electrically connected to the control device 3D. The second intelligent reflecting surface 2D-2, the fifth intelligent reflecting surface 2D-5, and the sixth intelligent reflecting surface 2D-6 are not provided with receiving antenna cells.

With the first receiving antenna cell 20D-1 as the reference, the second receiving antenna cell 20D-2 is located in the x-axis direction, and the third receiving antenna cell 20D-3 is located in the y-axis direction. Therefore, the control device 3D can calculate the angle deviation θ₁₂ and the angle deviation θ₁₃ based on the intensities of the radio waves received by the first receiving antenna cell 20D-1 to the third receiving antenna cell 20D-3, and correct the reflecting direction of each of the plurality of intelligent reflecting surfaces 2C of the intelligent reflecting surface system 4D.

The reflecting device 1C according to an embodiment of the present invention and the modification are described above. The reflecting device 1C includes the intelligent reflecting surface system 4C that includes three receiving antenna cells 20C for receiving incident radio waves. Further, the reflecting device 1C includes the control device 3C that acquires the intensities of the radio waves received by the receiving antenna cells 20C and calculates the angle deviations of the installation angle of the intelligent reflecting surface system 4C based on the radio wave intensities. Furthermore, the control device 3C can generate a control voltage whose reflecting direction is corrected based on the angle deviations. Therefore, the reflecting device 1C can accurately reflect a radio wave in a predetermined direction in each of the plurality of intelligent reflecting surfaces 2C included in the intelligent reflecting surface system 4C, regardless of the installation angle of the intelligent reflecting surface system 4C.

Each embodiment described as embodiments of the present invention can be combined as appropriate as long as they do not contradict each other. Based on each embodiment, any addition, deletion or design change of configuration components, or any addition, omission or change of conditions of the process, made by a person skilled in the art as appropriate, is also included in the scope of the invention, as long as it has the gist of the invention.

It is understood that other advantageous effects different from the advantageous effects resulting from the mode of each embodiment disclosed above, but which are obvious from the description of the present specification or which can be easily foreseen by a person skilled in the art, are naturally brought about by the present invention.

What is claimed is:

1. A reflecting device, comprising:
an intelligent reflecting surface comprising:
a reflecting antenna portion for reflecting a radio wave; and
a receiving antenna portion for receiving the radio wave; and
a control device for controlling a reflection direction of the radio wave reflected by the reflective antenna portion,
wherein the reflecting antenna portion comprises a plurality of reflecting antenna cells arranged in a matrix in a first direction and a second direction orthogonal to the first direction,
wherein each of the plurality of reflecting antenna cells comprises:
a first patch electrode,
a first ground electrode overlapping the first patch electrode, and
a liquid crystal layer between the first patch electrode and the first ground electrode,
wherein the receiving antenna portion comprises a first receiving antenna cell and a second receiving antenna cell disposed in the first direction from the first receiving antenna,
wherein the control device comprises:
a radio wave acquisition section for acquiring a first intensity of the radio wave received by the first receiving antenna cell and a second intensity of the radio wave received by the second receiving antenna cell,
an angle deviation calculation section for calculating a first angle deviation of a normal direction to a surface of the intelligent reflecting surface in the first direction based on a difference between the first intensity and the second intensity, and
a control voltage generation section for generating a control voltage to be applied to the first patch electrode of each of the plurality of reflecting antenna cells, and
wherein the control voltage is generated based on the first angle deviation.

2. The reflecting device according to claim 1, wherein the receiving antenna portion is provided around the reflecting antenna portion.

3. The reflecting device according to claim 2, wherein each of the first receiving antenna cell and the second receiving antenna cell is provided outside a sealing member surrounding the liquid crystal layer.

4. The reflecting device according to claim 2, wherein each of the first receiving antenna cell and the second receiving antenna cell is provided at a corner of the intelligent reflecting surface.

5. The reflecting device according to claim 1, wherein the receiving antenna portion is provided over the reflecting antenna portion.

6. The reflecting device according to claim 1, wherein each of the first receiving antenna cell and the second receiving antenna cell is provided so as to overlap a sealing member surrounding the liquid crystal layer.

7. The reflecting device according to claim 1,
wherein the control voltage generation section determines whether the first angle deviation is greater than or equal to 1 degree or not, and
wherein when the first angle deviation is greater than or equal to 1 degree, the control voltage generation section generates the control voltage so that the reflection direction is corrected based on the first angle deviation.

8. The reflecting device according to claim 1,
wherein the receiving antenna portion further comprises a third receiving antenna cell disposed in the second direction from the first receiving antenna cell,
wherein the radio wave acquisition section further acquires a third intensity of the radio wave received by the third receiving antenna cell,
wherein the angle deviation calculation section further calculates a second angle deviation of the normal direction in the second direction based on a difference between the first intensity and the third intensity, and
wherein the control voltage is generated further based on the second angle deviation.

9. The reflecting device according to claim 8,
wherein the control voltage generation section further determines whether the second angle deviation is greater than or equal to 1 degree or not, and
wherein when the second angle deviation is greater than or equal to 1 degree, the control voltage generation section further generates the control voltage so that the reflection direction is corrected further based on the second angle deviation.

10. The reflecting device according to claim 1,
wherein each of the first receiving antenna cell and the second receiving antenna cell comprises:
a second patch electrode,
a second ground electrode overlapping the second patch electrode, and
a dielectric between the second patch electrode and the second ground electrode, and
wherein the dielectric is a sealing member surrounding the liquid crystal layer.

11. The reflecting device according to claim 1,
wherein each of the first receiving antenna cell and the second receiving antenna cell comprises:
a second patch electrode,
a second ground electrode overlapping the second patch electrode, and
a dielectric between the second patch electrode and the second ground electrode, and
wherein the dielectric is different from a sealing member surrounding the liquid crystal layer.

12. A reflecting device, comprising:
an intelligent reflecting surface system in which a plurality of intelligent reflecting surfaces each including a reflecting antenna portion for reflecting a radio wave are arranged in a matrix in a first direction and a second direction orthogonal to the first direction; and
a control device for controlling a reflection direction of the radio wave reflected by the reflective antenna portion of each of the plurality of intelligent reflecting surfaces,
wherein a first intelligent reflecting surface and a second intelligent reflecting surface disposed in the first direction from the first intelligent reflecting surface among the plurality of intelligent reflecting surfaces includes a first receiving antenna cell and a second receiving antenna cell, respectively,
wherein the reflecting antenna portion comprises a plurality of reflecting antenna cells arranged in a matrix in the first direction and the second direction,
wherein each of the plurality of reflecting antenna cells comprises:
a first patch electrode,
a first ground electrode overlapping the first patch electrode, and
a liquid crystal layer between the first patch electrode and the first ground electrode,
wherein the control device comprises:
a radio wave acquisition section for acquiring a first intensity of the radio wave received by the first receiving antenna cell and a second intensity of the radio wave received by the second receiving antenna cell,
an angle deviation calculation section for calculating a first angle deviation of a normal direction to a surface of the intelligent reflecting surface in the first direction based on a difference between the first intensity and the second intensity, and
a control voltage generation section for generating a control voltage to be applied to the first patch electrode of each of the plurality of reflecting antenna cells, and
wherein the control voltage is generated based on the first angle deviation.

13. The reflecting device according to claim 12, wherein each of the first receiving antenna cell and the second receiving antenna cell is provided at a corner of the intelligent reflecting surface system.

14. The reflecting device according to claim 12,
wherein the first receiving antenna cell is provided outside a sealing member surrounding the liquid crystal layer of the first intelligent reflecting surface, and
wherein the second receiving antenna cell is provided outside a sealing member surrounding the liquid crystal layer of the second intelligent reflecting surface.

15. The reflecting device according to claim 12,
wherein the control voltage generation section determines whether the first angle deviation is greater than or equal to 1 degree or not, and
wherein when the first angle deviation is greater than or equal to 1 degree, the control voltage generation section generates the control voltage so that the reflection direction is corrected based on the first angle deviation.

16. The reflecting device according to claim 1,
wherein a third intelligent reflecting surface disposed in the second direction from the first intelligent reflecting surface among the plurality of intelligent reflecting surfaces comprises a third receiving antenna cell,
wherein the radio wave acquisition section further acquires a third intensity of the radio wave received by the third receiving antenna cell,
wherein the angle deviation calculation section further calculates a second angle deviation of the normal direction in the second direction based on a difference between the first intensity and the third intensity, and
wherein the control voltage is generated further based on the second angle deviation.

17. The reflecting device according to claim 16,
wherein the control voltage generation section further determines whether the second angle deviation is greater than or equal to 1 degree or not, and
wherein when the second angle deviation is greater than or equal to 1 degree, the control voltage generation section further generates the control voltage so that the reflection direction is corrected further based on the second angle deviation.

18. The reflecting device according to claim 12,
wherein each of the first receiving antenna cell and the second receiving antenna cell comprises:
a second patch electrode,
a second ground electrode overlapping the second patch electrode, and
a dielectric between the second patch electrode and the second ground electrode, and
wherein the dielectric is a sealing member surrounding the liquid crystal layer.

19. The reflecting device according to claim 12,
wherein each of the first receiving antenna cell and the second receiving antenna cell comprises:
a second patch electrode,
a second ground electrode overlapping the second patch electrode, and
a dielectric between the second patch electrode and the second ground electrode, and
wherein the dielectric is different from a sealing member surrounding the liquid crystal layer.
